(19) United States
(12) Patent Application Publication
(10) Pub. No.: US 2018/0113058 A1
(43) Pub. Date: Apr. 26, 2018

(54) Exhaust Emission Measurement System and Method

(71) Applicant: HORIBA Europe GmbH, Darmstadt (DE)

(72) Inventors: Matthias SCHRÖDER, Bad Homburg vor der Höhe (DE); Thomas Eugen EHMANN, Heiningen (DE)

(21) Appl. No.: 15/558,901

(22) PCT Filed: Mar. 16, 2016
(86) PCT No.: PCT/EP2016/055688

§ 371 Date: Sep. 15, 2017

(30) Foreign Application Priority Data
Mar. 16, 2015 (EP) 15000772.2
Mar. 16, 2015 (EP) 15000773.0

(51) Int. Cl. G01N 1/22; G01M 15/10

(52) U.S. Cl. CPC G01N 1/2252; G01N 2001/2255; G01M 15/102

(57) ABSTRACT

An exhaust emission measurement method comprises the steps: —testing a Plug-In Hybrid Vehicle having a combustion engine and an electric motor during a test phase of a predetermined time length; —sampling of exhaust into dilution air; —collecting the diluted exhaust in a diluted exhaust bag, when the combustion engine is operating; —intermittently filling of the bag when a combustion engine of the Plug-In Hybrid Vehicle is operating; —at a certain time before the end of the test phase, changing sampling from intermittent filling to continuous filling of the bag in order to get enough bag volume for an accurate analyzer reading.

The invention refers to an exhaust emission measurement system and a method for operating this system.

Conventional constant volume sampling (CVS) is well known as a precision emissions measurement method for internal combustion engines, even though the concentrations of THC, NOX, CO and CH4 emitted from vehicles are getting lower by improvement of emissions control devices. Recently, fuel economy requirements have increased in many regions. Hybrid electric vehicle (HEV), or plug-in hybrid electric vehicle (PHEV), is one of the solutions for fuel economy improvement. HEVs and PHEVs have an all-electric range in which the internal combustion engines (ICEs) are completely shut down. This operation during CVS results in a high dilution factor (DF) and low concentrations of gaseous components, including CO2, in the CVS system. Such dilution conditions directly cause an increase of numerical error for DF and an analysis error for gaseous components.

The uncertainties for diluted exhaust sampling of PHEVs with numerous ICE start/stop situations are investigated, especially regarding to emission measurement accuracy under the European regulation R83. Since some PHEVs with long range capability are able to operate for large parts of a driving cycle with only the electric motor, the amount of exhaust in the diluted exhaust batch samples (e.g. bags) decreases thus leading to lower measurement accuracies.

The variety of increasingly complex powertrains including Plug-In Hybrid Electric Vehicles (PHEVs) is associated with a number of challenges to measure exhaust gas emissions: Although the conventional constant volume sampling (CVS) and exhaust gas measurement systems remain a high precision emission measurement concept new questions occur that need to be answered, such as mass transport, catalyst cooling during ICE-off and emission measurement accuracy.

Emission measurement accuracy is influenced since PHEV are partially operated with the electric motor during a driving cycle, or switched off while idling. Therefore concentrations of gaseous components in the diluted exhaust batches are decreasing, which causes an increase in analysis error.

Measurement accuracy is influenced hence during driving cycles driven with Plug-In Hybrid Electric Vehicles the amount of exhaust emissions continuously decreases since the high electrical range allows a PHEV to drive large parts of a cycle all electrical. The feasibility to operate the engine at more efficient map points, shut down the engine while the vehicle stops and charging the battery during deceleration reduces the exhaust volume furthermore.

The European legislation defines measurement accuracy requirements for gas analyzers for CO2 and other gaseous emissions in regulation ECE-R83. To achieve high measurement accuracies the exhaust concentrations in the exhaust batches should be as high as possible. But even with optimized CVS volume flows high dilution factors (DF) in the exhaust batches cannot be avoided when testing PHEV, since only dilution air is sampled when the combustion engine is not operating. Thus dilution factors easily exceed the recommended DF of below 25.

### Object

It is an object of the present invention to provide a system and a method for exhaust emission measurement which allows a decrease of the dilution factor DF and thus an increase of the emission concentrations in an exhaust batch sample so that the accuracy of exhaust measurement in particular for plug-in hybrid electric vehicles can be improved.

### Solution

The object is solved by an exhaust emission measurement method according to claim 1 and by an exhaust emission measurement system operated with that method in accordance with the parallel independent claim. Further embodiments are defined by the dependent claims.

An exhaust emission measurement method is provided, with the steps of testing a plug-in hybrid vehicle having a combustion engine and an electric motor during a test phase of a predetermined time length; sampling of exhaust from the combustion engine into dilution air; intermittently filling of a diluted exhaust bag with the diluted exhaust, when the combustion engine is operating; at a certain time before the end of the test phase, changing sampling from intermittent filling to continuous filling of the bag in order to get enough bag volume for an accurate analyzer reading.

Exhaust from the combustion engine means that it is the emissions taken from the exhaust of the vehicle.

When a necessary minimum bag volume for the following analysis of the exhaust components will not be reached in the test phase due to insufficient engine operation (e.g., if the run time of the engine is too short), the diluted exhaust bag is filled automatically as the end of the test phase approaches.

Thus, filling of the bag takes place, when the combustion engine is operating. However, when the end of the test phase approaches and the necessary minimum bag volume which is required for a proper and precise analysis will not be reached by the end of the test phase, the bag is additionally filled by the dilution air.

The method may comprise the further steps of: starting the test phase having the predetermined test phase time length; sampling of exhaust into dilution air and filling diluted exhaust in the diluted exhaust bag, when the combustion engine is operating; counting an accumulated filling time as a parameter for the time during which the bag is filled; calculating a remaining filling time as a difference between a minimum filling time and the accumulated filling time; if the combustion engine is not operating and if the remaining phase time until the end of the test phase is lower than or equal to the remaining filling time, filling the bag.

The parameter of the accumulated filling time is thus a value representing the time how long the bag has been filled.

The minimum filling time should be determined in advance, i.e. before the test phase is started. For example, the minimum filling time can be estimated depending on the specific combustion engine, the expected amount (volume), exhaust per time unit, the testing conditions, the technical specifications and rules according to which the test has to be performed, etc.

The filling of the bag can depend on one or more valves which allow that air from a CVS dilution tunnel is guided to the bag or a bypass.

If the combustion engine is not operating and if the remaining phase time until the end of the test phase is greater than the remaining filling time, the filling of the bag can be stopped.

The step of filling the bag can comprise the steps of: providing a valve between sampling means and the respective bag; switching the valve in accordance with operation of the combustion engine such that, when the combustion engine is operated, the valve opens to the bag so that the bag is filled, and when the combustion engine is stopped, the valve switches to a bypass where the sample is dismissed so that the bag is not filled.

Such sampling means can be e.g. venturis in a CVS system.

After the combustion engine has stopped, it is possible to continue filling of the bag for a predetermined post filling time. Thus, the filling of the bag can be continued for e.g. 5 s after the combustion engine stopped in order to sample the diluted exhaust gas delayed by the volume of the system piping.

In order to increase the emission concentrations in the exhaust batch samples, a new measurement procedure is proposed. When applying this new procedure called “During-Test-Top-Off (DTTO)”, exhaust is only sampled into the dilution air and diluted exhaust bags when the combustion engine of the PHEV is operating. In the case when the necessary minimum bag volume for analysis will not be reached in a phase due to insufficient engine operation, then the bags will be continuously filled as the end of the test phase approaches.

To increase the concentration of gaseous components of interest in the sample batch the system fills a probe of the diluted exhaust gas only while the internal combustion engine is operating. Since this total filling time might be very short because the ICE might operate only very view and/or short time, the amount of sampled gas in the batch (e.g. sample bag) is too small for the analysis with the gas measurement instruments after the test has been finished. The invention is that the automation system calculates the total amount (volume of diluted exhaust gas) by knowing the filling rate into the sample bag (liters/minute) and the actual elapsed filling time. By knowing the actual volume in the bag the automation system can calculate when at latest the system needs to start filling the sample bag regardless the ICE is operating or not, to ensure the sampled gas amount is enough for the analysis after the test.

This leads to the result that the sampled gas volume in the bag is enough for the complete analysis.

The filling during the test (instead of after the test) will save the time for the whole test procedure (the time that would be required to top-off the sample after the test has been finished).

Since it cannot be assured that the dilution air (Background) concentration is stable and might be changed after the test is finished, it is an advantage that no sample is added after the end of the test than it would have been during the test.

The new method shall be called “During Test Top Off” (DTTO). DTTO only samples emissions into the exhaust batches when the combustion engine is operated or—if the minimal batch volume has not been reached yet—tops-off to sufficient volume near the end of a driving cycle.

In the measurement method DTTO the exhaust gas and dilution air are only filled into the bags during operation of the combustion engine and thus reducing high dilution factors due to mere diluent sampling. Considering minimum bag sampling time for a proper analysis volume, top-off sampling will be (re-)started approaching the end of each phase even without engine operation.

When the combustion engine was not operating 3-2 way valves between the sample venturis and the batches were switched to bypass the batches and the sample flows were dismissed. As soon as combustion engine operation was detected the 3-2 way valves were switched and the batches were filled with diluted exhaust gas and dilution air. The filling of the batches continued for 5 s after the ICE stopped in order to sample the diluted exhaust gas delayed by the volume of the system piping.

Near the end of a cycle phase if the minimum batch volume for an accurate analyzer reading has not been filled yet due to very few ICE operation the 3-2 way valves open continuously to the batches. This continuous batch filling lasts until the end of the phase. For the next cycle phase and therefore the next couple of batches the alternative procedure starts over again.

Furthermore, during driving cycles it can happen that Plug-In Hybrid Electric Vehicles drive the majority of the cycle pure electrical and therefore only few combustion-engined emissions are sampled in the diluted exhaust gas batches, with the rest being only diluent sampled. This can cause non-compliance with the European emission regulation 83 due to high measurement errors for the CO2 emission getting to low batch concentrations. According to the measurement procedure where the dilution air and a diluted exhaust gas batches are only filled when the combustion engine is operated. Moreover, bag volume is topped-off approaching the end of the phase for sufficient analyzing volume but on the same time not increasing test length. The method increases the emission concentrations in the diluted exhaust gas batches and effectively decreases the measurement error.

Starting from a full battery for a given OVC type hybrid vehicle, the combustion engine might not run while running an emission-phase measurement. This means, that a running bag-fill will just put ambient air into the sample bag.

To avoid over-dilution during the bag-fill, partial bag-fill is realized providing a solution without changes to the CVS system.

Moreover, an exhaust emission measurement system is provided which is operated by the above method.

Hereinafter, the invention is described in more detail by means of the following Figures, wherein

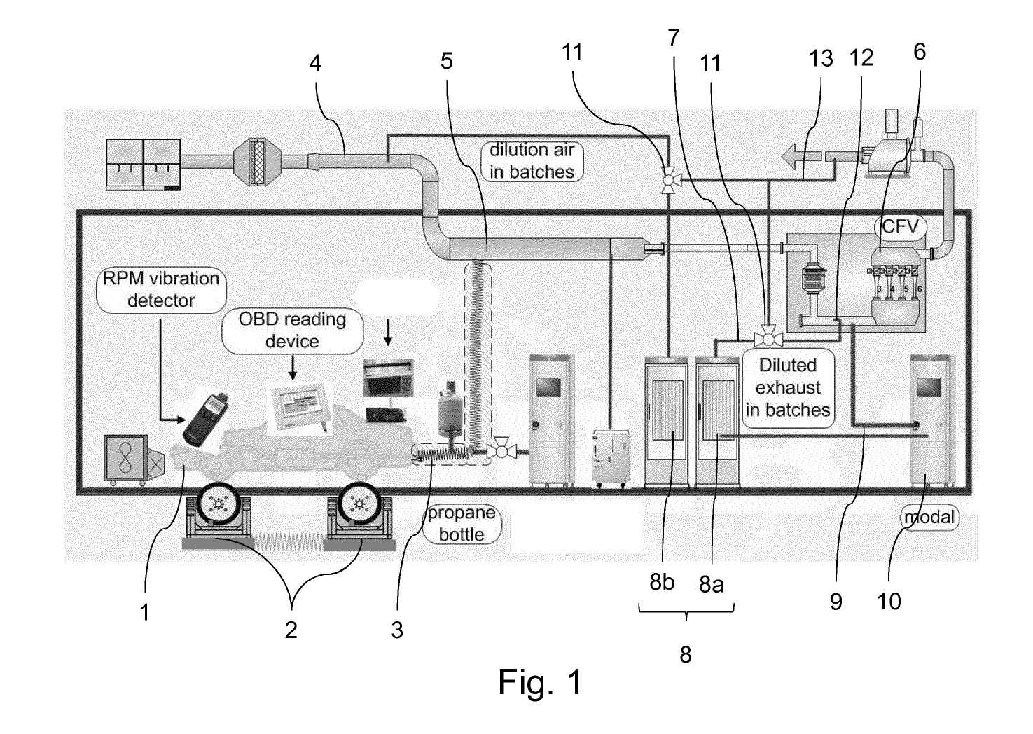

FIG. 1 shows an emission measurement system according to the present invention;

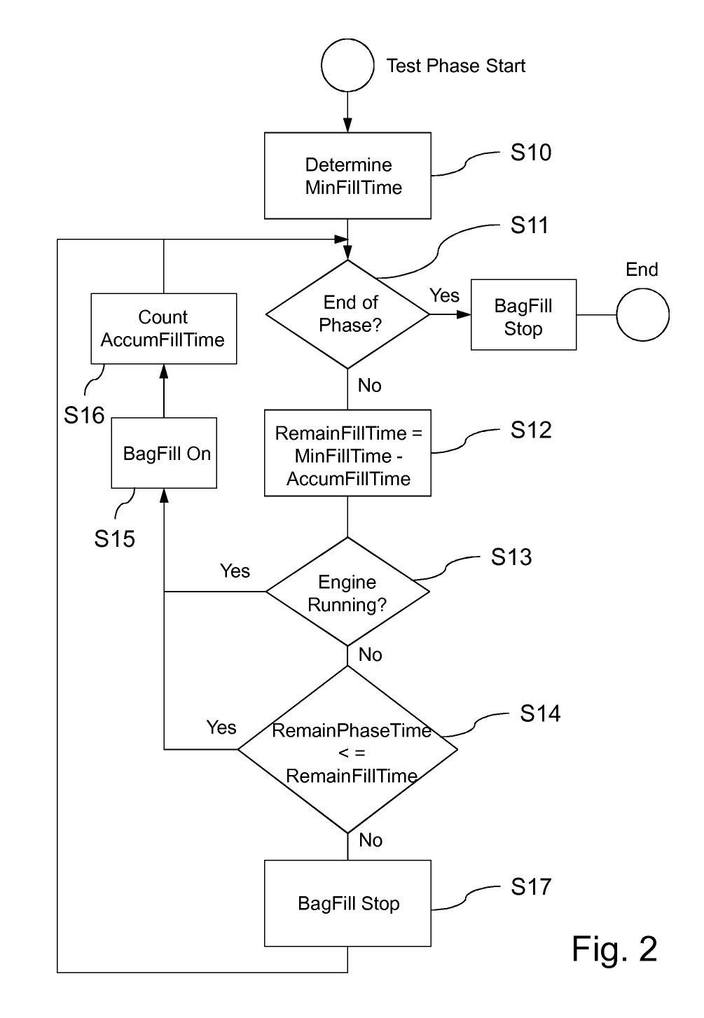

FIG. 2 shows a flow chart with an exhaust emission measurement method according to the present invention;

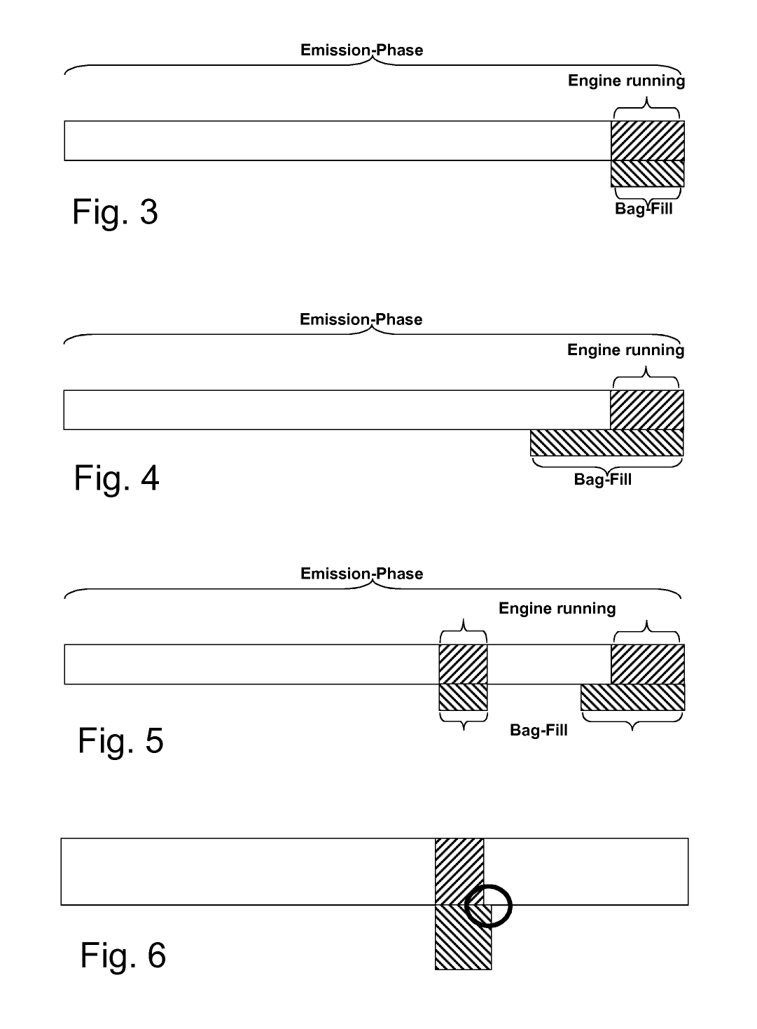

FIG. 3 is a time scheme showing a partial bag-fill without adjusted bag-fill time;

FIG. 4 shows a partial bag-fill with adjusted bag-fill time according to the present invention;

FIG. 5 shows a partial bag-fill with multiple engine on/off phases; and

FIG. 6 shows a partial bag-fill considering a post-fill time.

The test cell and emission sampling system configuration according to the invention is schematically illustrated in FIG. 1.

A Plug-In Hybrid Electric Vehicle 1 (PHEV) is driven on a 4WD chassis dynamometer 2. The vehicle's tailpipe 3 is connected to a heated transfer tube (3.5 m flexible and 2.5 m steel tube) and the entire exhaust flow is diluted by a CVS system 4 (dilution tunnel 5 positioned in 2.5 m height), with critical flow venturis 6 (CFV) assuring a constant diluted exhaust flow.

A sample 7 of diluted exhaust is drawn into bags 8 (here: bag 8a) for post-test analysis. Modal sampling lines 9, connected directly to an exhaust gas analyzer system 10, allow modal diluted exhaust measurement during driving cycles.

3-2 way valves 11 are arranged between sampling venturis 12 and the batches (bags 8). The valves 11 are used to switch according to the operation of the combustion engine in the PHEV 1: When the combustion engine is operated the valves 11 open to the bags 8 (diluted exhaust 8a and dilution air 8b). When the combustion engine is stopped the valves 11 switch to a bypass 13 where the sample is dismissed. Yet this entire system configuration is the same as a conventional CVS system.

FIG. 2 shows a flow chart according to the measurement system.

At the beginning at the test phase start in step S10, a value of the minimum filling time (MinFillTime) is determined depending on the expected exhaust volume per time unit, the testing conditions, technical regulations etc. The minimum filling time is the time which is necessary for filling sufficient volume into the respective bag so that after the test end, sufficient material (diluted exhaust or dilution air) can be used for the following analysis procedures.

In step S11 it is decided whether the test phase can already end, if the total test time has been reached. If the end of the test phase has been reached, filling of the bag is stopped.

If the test phase has not been ended, in step S12, the remaining filling time is calculated as the difference between the minimum filling time and an accumulated filling time. The accumulated filling time is the time during which the bag is filled. If the bag is not filled, the accumulated filling time is not increased (not counted upwards).

Thus, the remaining filling time is the value which shows how long the bag still must be filled until the minimum filling time has been reached.

In step S13, it is determined whether the engine is running or not.

If the engine is running, the method continues with filling the bag in step S15. During this phase, exhaust from the combustion engine enters the dilution tunnel and can thus be filled as diluted exhaust into the bag.

Filling the bag in step S15 is possible by switching the corresponding valve 11 accordingly. The valve 11 can be switched such that air from the dilution tunnel 5 can be guided to the bag. This air can be just dilution air (without any exhaust, if the engine is not running) or diluted exhaust from the engine.

In step S16, the accumulated filling time is thus counted upwards, since the filling of the bag is continued.

If, however, it is determined in step S13 that the engine is not running, it is decided in the following step S14 whether the remaining phase time is equal to or less than the remaining filling time. If the remaining phase time has reached (is greater than) the remaining filling time, there is no filling of the bag (step S17) and the method continues to step S11.

In step S17, the valve 11 is switched such that no further from the dilution tunnel 5 can flow into the bag.

If, however, the remaining phase time is less than the remaining filling time, the filling of the bag is continued by switching the valves accordingly (step S15).

By this procedure, the filling of the bag at the end of the test phase is independent of whether the engine is running or not. Rather, if it can be calculated that the filling of the bag has not reached the required minimum, the bag is filled by the dilution air in the CVS tunnel (dilution tunnel 5) even if the engine is not running.

Examples for different method principles and time schemes are given below.

FIG. 3 shows a conventional method, where the combustion engine only kicks in at the end of the emission-phase.

In particular, FIG. 3 shows the time of a complete test phase (Emission-Phase) during which a PHEV is tested, wherein the combustion engine is only running at the very end of the total test phase. As the diluted exhaust bag is only filled during the run-time of the engine, the filling of the bag also only takes place at the end of the phase.

As the exhaust in the sample bag shall not be over-diluted with ambient air, the bag-pair is only filled while the combustion-engine is running. If the bag-pair is only filled for a certain time during the emission-phase, this will be called a “partial bag-fill”.

Partial bag-fill, however, leads to the problem that it is difficult to determine the length of the total bag-fill time within one emission-phase (the engine might kick-in not only one time). The system will require a minimum bag-fill time to get enough gas into the bags for a complete bag-read of those bags.

FIG. 4 shows the effect of the method according to the present invention.

Depending on the selected bag-fill venturi (e.g. venturi 12 in FIG. 1) and the used bag-bench a minimum bag-fill time can be defined in advance of a test phase (MinFillTime in FIG. 2).

If the time (where the combustion engine is not running) is shorter than the required bag-fill time, the bag-fill starts even without the combustion engine running and thus earlier than the engine.

Assuming a required bag-fill time of 180 seconds, the bag-fill needs to be started latest 180 seconds before the end of the emission-phase. This is shown in the FIG. 4 scenario where the bag-fill starts even when the combustion engine has not started yet.

FIG. 5 shows a scenario where the combustion engine will kick-in twice.

With the first start of the combustion engine bag-fill will start and stop when the engine is going off, as the remaining time is still long enough. As there is now already a certain amount of sample-gas in the bags, the second bag-fill will start later, still to achieve a total fill time of 180 seconds.

FIG. 6 shows a situation where the bag-fill is continued (see the circle) although the engine has already stopped. The filling of the bag thus can be continued for a certain time (e.g. 5 s) after the engine stopped in order to sample the diluted exhaust gas delayed by the volume of the system piping.

Thus, on partial bag-fill the post filling time can be applied to the bag-fill to catch the remaining gas in the tubing.

1-6. (canceled)

7. An exhaust emission measurement method, comprising:
starting a test phase having a predetermined test phase time length;
testing a Plug-In Hybrid Vehicle having a combustion engine and an electric motor during the test phase;
sampling exhaust from the combustion engine into dilution air;
intermittently filling a diluted exhaust bag with diluted exhaust, when the combustion engine is operating;
at a certain time before the end of the test phase, changing sampling from intermittent filling to continuous filling of the diluted exhaust bag to provide enough bag volume for an accurate analyzer reading;
counting an accumulated filling time as a parameter for the time during which the diluted exhaust bag is filled;
calculating a remaining filling time as a difference between a minimum filling time and the accumulated filling time;
if the combustion engine is not operating and if the remaining phase time until the end of the test phase is lower than or equal to the remaining filling time, filling the diluted exhaust bag; and
continuing filling of the diluted exhaust bag for a predetermined post filling time after the combustion engine has stopped.

8. The method of claim 7, further comprising:
if the combustion engine is not operating and if the remaining phase time until the end of the test phase is greater than the remaining filling time, stop filling the diluted exhaust bag.

9. The method of claim 7, wherein filling the diluted exhaust bag comprises:
providing a valve between sampling means and the diluted exhaust bag; and
switching the valve in accordance with the operation of the combustion engine such that, when the combustion engine is operated, the valve opens to the diluted exhaust bag so that the diluted exhaust bag is filled, and when the combustion engine is stopped, the valve switches to a bypass where the sample is dismissed so that the diluted exhaust bag is not filled.

10. The method of claim 7, further comprising:
predefining the minimum filling time as a time needed for filling sufficient diluted exhaust in the diluted exhaust bag to measure concentrations of gaseous components in the diluted.

11. The method of claim 7, wherein at least two bags are provided, wherein one of the at least two bags is the diluted exhaust bag, and wherein the other of the at least two bags is a bag for dilution air.

12. An exhaust emission measurement system, comprising:
an exhaust gas analyzer system configured to start a test phase having a predetermined test phase time length during which a Plug-In Hybrid Vehicle having a combustion engine and an electric motor is tested, count an accumulated filling time as a parameter for a time during which the diluted exhaust bag is filled, and calculate a remaining filling time as a difference between a minimum filling time and the accumulated filling time;
a diluted exhaust bag configured to draw in diluted exhaust from the combustion engine;
a sampling venturis configured to sample exhaust from the combustion engine into dilution air; and
one or more valves configured to open to the diluted exhaust bag for intermittently filling the diluted exhaust bag with diluted exhaust when the combustion engine is operating, and at a certain time before the end of the test phase to change sampling from intermittent filling to continuous filling of the diluted exhaust bag to provide enough bag volume for an accurate analyzer reading,
wherein if the combustion engine is not operating and if the remaining phase time until the end of the test phase is lower than or equal to the remaining filling time, the diluted exhaust bag is filled,
wherein the one or more valves are configured to open to the diluted exhaust bag for continuing filling of the diluted exhaust bag for a predetermined post filling time after the combustion engine has stopped.

13. The exhaust emission measurement system of claim 12, wherein if the combustion engine is not operating and if the remaining phase time until the end of the test phase is greater than the remaining filling time, the one or more valves are configured to stop filling the diluted exhaust bag.

14. The exhaust emission measurement system of claim 12, wherein the one or more valves are configured to switch in accordance with the operation of the combustion engine such that, when the combustion engine is operated, the one or more valves open to the diluted exhaust bag so that the diluted exhaust bag is filled, and when the combustion engine is stopped, the one or more valves switch to a bypass where the sample is dismissed so that the diluted exhaust bag is not filled.

15. The exhaust emission measurement system of claim 12, wherein the exhaust gas analyzer system configured to predefine the minimum filling time as a time needed for filling sufficient diluted exhaust in the diluted exhaust bag to measure concentrations of gaseous components in the diluted.

16. The exhaust gas analyzer system of claim 12, wherein at least two bags are provided, wherein one of the at least two bags is the diluted exhaust bag, and wherein the other of the at least two bags is a bag for dilution air.
